(19) United States
(12) Patent Application Publication
(10) Pub. No.: US 2023/0399967 A1
(43) Pub. Date: Dec. 14, 2023

(54) EXHAUST GAS CONTROL APPARATUS OF INTERNAL COMBUSTION ENGINE

(71) Applicant: TOYOTA JIDOSHA KABUSHIKI KAISHA, Toyota-shi (JP)

(72) Inventors: Ryosuke KAYANUMA, Sunto-gun (JP); Tetsuya SAKUMA, Sunto-gun (JP)

(73) Assignee: TOYOTA JIDOSHA KABUSHIKI KAISHA, Toyota-shi (JP)

(21) Appl. No.: 18/125,191

(22) Filed: Mar. 23, 2023

(30) Foreign Application Priority Data
Jun. 9, 2022 (JP) 2022-093627

(51) Int. Cl. F01N 3/20; B01D 53/94; F01N 9/00; B01D 53/32; F01N 11/00

(52) U.S. Cl. CPC F01N 3/20; B01D 53/9495; F01N 9/00; B01D 53/326; F01N 11/007; B01D 53/9454; F01N 2550/02; B01D 2255/908; B01D 2257/502; B01D 2258/012; B01D 2257/702; F01N 2900/1402; B01D 2257/404

(57) ABSTRACT

An exhaust gas control apparatus for an internal combustion engine for purifying exhaust gas discharged from an engine main body includes an exhaust gas control catalyst disposed in an exhaust gas passage of an internal combustion engine and capable of purifying a target component in the exhaust gas, an electrochemical reactor disposed in the exhaust gas passage on a downstream side in an exhaust flow direction of the exhaust gas control catalyst, and a control device for controlling energization of the electrochemical reactor. The electrochemical reactor is configured to purify the target component in the exhaust gas when energized. The control device controls the energization of the electrochemical reactor on the basis of an active parameter indicating an active state of the exhaust gas control catalyst and an air-fuel ratio parameter related to an air-fuel ratio of the inflow exhaust gas flowing into the electrochemical reactor.

### CROSS-REFERENCE TO RELATED APPLICATION

This application claims priority to Japanese Patent Application No. 2022-093627 filed on Jun. 9, 2022, incorporated herein by reference in its entirety.

### BACKGROUND

### 1. Technical Field

The present disclosure relates to an exhaust gas control apparatus for an internal combustion engine.

### 2. Description of Related Art

Conventionally, there has been known an exhaust gas control apparatus of an internal combustion engine including an electrochemical reactor that includes an ion-conductive solid electrolyte layer, an anode layer disposed on a surface of the solid electrolyte, and a cathode layer disposed on a surface of the solid electrolyte (Japanese Unexamined Patent Application Publication No. 8-238422 (JP 8-238422 A) and Japanese Unexamined Patent Application Publication No. 2019-196748 (JP 2019-196748 A)).

In particular, JP 2019-196748 A discloses that when the temperature of the exhaust gas control catalyst is lower than its activation temperature, a current is supplied to the electrochemical reactor to control the exhaust gas in the electrochemical reactor, and when the temperature of the exhaust gas control catalyst is equal to or more than the activation temperature, the supply of the current to the electrochemical reactor is stopped.

### SUMMARY

In JP 2019-196748 A, when the temperature of the exhaust gas control catalyst becomes equal to or higher than the activation temperature, the supply of the current to the electrochemical reactor is stopped. However, even when the temperature of the exhaust gas control catalyst is equal to or higher than the activation temperature, there is a case in which a component that is a control target flows out from the exhaust gas control catalyst during the operation of the internal combustion engine.

In view of the above problems, an object of the present disclosure is to suppress a component that is a control target from flowing out of an exhaust gas control apparatus during operation of an internal combustion engine in the exhaust gas control apparatus by using an electrochemical reactor.

The summary of the present disclosure is as follows.

An exhaust gas control apparatus of an internal combustion engine according to a first aspect of the present disclosure is the exhaust gas control apparatus of the internal combustion engine in which the exhaust gas control apparatus controls exhaust gas discharged from an engine body, and the exhaust gas control apparatus of the internal combustion engine is configured to include:
an exhaust gas control catalyst that is disposed in an exhaust gas passage of the internal combustion engine and that is configured to control a target component in the exhaust gas; an electrochemical reactor that is disposed in the exhaust gas passage on a downstream side of an exhaust gas flow direction of the exhaust gas control catalyst and that is configured to control the target component in the exhaust gas when energized; and
a control device that controls energization of an electrochemical reactor based on an active parameter indicating an active state of the exhaust gas control catalyst and an air-fuel ratio parameter related to an air-fuel ratio of an inflow exhaust gas that flows into the electrochemical reactor.

In the exhaust gas control apparatus according to the first aspect of the present disclosure, the control device is configured to control energization of the electrochemical reactor such that energization of the electrochemical reactor is performed when the active parameter is a value indicating that the exhaust gas control catalyst is active and the air-fuel ratio parameter is a value indicating that the air-fuel ratio of the inflow exhaust gas is an air-fuel ratio that differs from a stoichiometric air-fuel ratio.

In the exhaust gas control apparatus according to the first aspect, the control device is configured to control energization of the electrochemical reactor such that energization of the electrochemical reactor is not performed when the active parameter is a value indicating that the exhaust gas control catalyst is active and the air-fuel ratio parameter is a value indicating that an air-fuel ratio of the inflow exhaust gas is a stoichiometric air-fuel ratio.

The exhaust gas control apparatus according to the first aspect of the present disclosure further includes:
an air-fuel ratio sensor that detects an air-fuel ratio of exhaust gas flowing out of the exhaust gas control catalyst and flowing into the electrochemical reactor.
Here, the air-fuel ratio parameter is an air-fuel ratio detected by the air-fuel ratio sensor.

In the exhaust gas control apparatus according to the first aspect, the exhaust gas control catalyst is configured to store oxygen, and the air-fuel ratio parameter is an oxygen storage amount of the exhaust gas control catalyst.

In the exhaust gas control apparatus according to the first aspect, the control device is configured to control energization of the electrochemical reactor such that energization of the electrochemical reactor is performed when the active parameter is a value indicating that the exhaust gas control catalyst is active and the oxygen storage amount of the exhaust gas control catalyst is zero or a maximum storable oxygen amount.

In the exhaust gas control apparatus according to the first aspect, the control device is configured to control energization of the electrochemical reactor such that energization of the electrochemical reactor is not performed when the active parameter is a value indicating that the exhaust gas control catalyst is active and the oxygen storage amount of the exhaust gas control catalyst is not zero or a maximum storable oxygen amount.

In the exhaust gas control apparatus according to the first aspect, the control device is configured to control energization of the electrochemical reactor such that energization of the electrochemical reactor is performed after a predetermined time has elapsed after the oxygen storage amount of the exhaust gas control catalyst reaches zero or a maximum storable oxygen amount, and
the predetermined time is set to be shorter than when a flow rate of the exhaust gas discharged from the engine body is high compared to when the flow rate is low.

The exhaust gas control apparatus according to the first aspect, the control device controls energization of the electrochemical reactor such that energization of the electrochemical reactor is performed regardless of a value of the air-fuel ratio when the active parameter is a value indicating that the exhaust gas control catalyst is not active.

The exhaust gas control apparatus according to the first aspect of the present disclosure further includes:
an NOx sensor that detects an NOx level in the exhaust gas flowing out of the exhaust gas control catalyst and prior to flowing into the electrochemical reactor.
Here, the active parameter is the NOx density detected by the NOx sensor or a parameter calculated based on the NOx density.

According to the present disclosure, a component that is a control target can be suppressed from flowing out of an exhaust gas control apparatus during operation of an internal combustion engine in the exhaust gas control apparatus by using an electrochemical reactor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an internal combustion engine in which an exhaust gas control apparatus according to a first embodiment is mounted;

FIG. 2 is a cross-sectional side view of an electrochemical reactor;

FIG. 3 is an enlarged cross-sectional view of a partition wall of an electrochemical reactor;

FIG. 4 is a time chart of various parameters when the operation of the reactor according to the first embodiment is controlled:

FIG. 5 is a flow chart of a control routine of operation of the reactor according to the first embodiment;

FIG. 6 is a schematic configuration diagram of an internal combustion engine in which an exhaust gas control apparatus according to a second embodiment is mounted;

FIG. 7 is a time chart of various parameters when the operation of the reactor according to the second embodiment is controlled;

FIG. 8 is a flow chart of a control routine of operation of the reactor according to the second embodiment;

FIG. 9 is a diagram illustrating a relationship between the cumulative operation time of the internal combustion engine and the maximum storable oxygen amount;

FIG. 10 is a time chart of an operation request of the reactor, a flow rate of the exhaust gas, and an operation state of the reactor.

### DETAILED DESCRIPTION OF EMBODIMENTS

Hereinafter, embodiments will be described in detail with reference to the drawings. In the following description, similar component parts are given the same reference numbers.

### First Embodiment

Description of the Entire Internal Combustion Engine

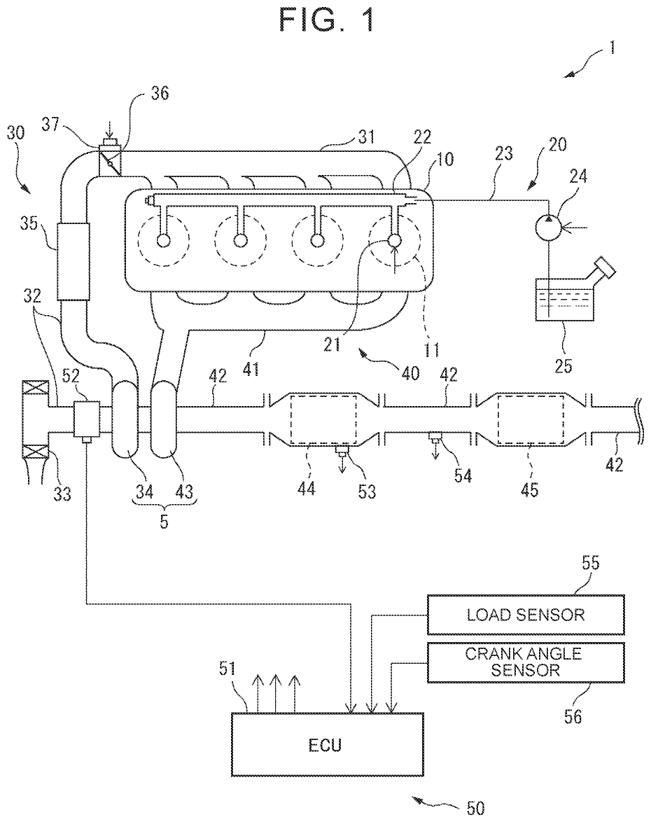

With reference to FIG. 1, a configuration of an internal combustion engine 1 in which an exhaust gas control apparatus according to a first embodiment is mounted is described. FIG. 1 is a schematic block diagram of the internal combustion engine 1. As illustrated in FIG. 1, the internal combustion engine 1 includes an engine main body 10, a fuel supply device 20, an intake system 30, an exhaust system 40, and a control device 50. An exhaust gas control apparatus for purifying the exhaust gas discharged from the engine main body 10 includes components of an exhaust system 40 and a control device 50.

The engine main body 10 includes a cylinder block, a cylinder head, and a crank case. In the cylinder block, a plurality of cylinders 11 is formed. In the cylinder head, intake ports and exhaust ports are formed. In each of the cylinders 11, a piston is disposed. The cylinders 11 communicate with the intake ports and the exhaust ports, respectively.

The fuel supply device 20 includes a fuel injection valve 21, a delivery pipe 22, a fuel supply pipe 23, a fuel pump 24, and a fuel tank 25. The fuel injection valve 21 is disposed in the cylinder head so as to directly inject fuel into the cylinders 11. The fuel pumped by the fuel pump 24 is supplied to the delivery pipe 22 via the fuel supply pipe 23, and is injected into the cylinders 11 from the fuel injection valve 21.

The intake system 30 includes an intake manifold 31, an intake pipe 32, an air cleaner 33, a compressor 34 of the supercharger 5, an intercooler 35, and a throttle valve 36. The intake ports of the cylinders 11 communicate with the air cleaner 33 via the intake manifold 31 and the intake pipe 32. A compressor 34 of the supercharger 5 that compresses and discharges the intake air and an intercooler 35 that cools the air compressed by the compressor 34 are provided in the intake pipe 32. The throttle valve 36 is opened and closed by a throttle valve drive actuator 37.

The exhaust system 40 includes an exhaust manifold 41, an exhaust pipe 42, a turbine 43 of the supercharger 5, an exhaust gas control catalyst 44, and an electrochemical reactor (hereinafter, simply referred to as “reactor”) 45. The exhaust port of each cylinder 11 communicates with the exhaust gas control catalyst 44 via the exhaust manifold 41 and the exhaust pipe 42, and the exhaust gas control catalyst 44 communicates with the reactor 45 via the exhaust pipe 42. A turbine 43 of the supercharger 5, which is rotationally driven by the energy of the exhaust gas, is provided in the exhaust pipe 42. The exhaust port, the exhaust manifold 41, the exhaust pipe 42, the exhaust gas control catalyst 44, and the reactor 45 form an exhaust gas passage. Therefore, the exhaust gas control catalyst 44 and the reactor 45 are disposed in the exhaust gas passage. Further, the reactor 45 is disposed on the downstream side of the exhaust gas control catalyst 44 in the flow direction (exhaust flow direction) of the exhaust gas.

The exhaust gas control catalyst 44 is, for example, a three-way catalyst, and purities components in the exhaust gas such as NOx and unburned HC, CO when the air-fuel ratio of the exhaust gas is the stoichiometric air-fuel ratio when the air-fuel ratio becomes equal to or higher than a certain activation temperature. The exhaust gas control catalyst 44 has an oxygen storage capacity. Accordingly, the exhaust gas control catalyst 44 stores oxygen in the exhaust gas when the air-fuel ratio of the exhaust gas flowing in the exhaust gas control catalyst 44 is a lean air-fuel ratio that is leaner than the stoichiometric air-fuel ratio, and releases the stored oxygen when the air-fuel ratio of the exhaust gas flowing in the exhaust gas control catalyst 44 is a rich air-fuel ratio that is richer than the stoichiometric air-fuel ratio. Therefore, when the exhaust gas having the lean air-fuel ratio flows into the exhaust gas control catalyst 44, the oxygen in the exhaust gas is stored in the exhaust gas control catalyst 44, and the air-fuel ratio of the exhaust gas becomes the stoichiometric air-fuel ratio, so that NOx, the unburned HC, CO, and the like in the exhaust gas are purified. However, when the oxygen storage amount of the exhaust gas control catalyst 44 becomes substantially the largest storable oxygen amount, the exhaust gas control catalyst 44 cannot store oxygen any more, and thus cannot purify NOx in the exhaust gas. On the other hand, when the exhaust gas having the rich air-fuel ratio flows into the exhaust gas control catalyst 44, oxygen is released from the exhaust gas control catalyst 44, and the air-fuel ratio of the exhaust gas becomes the stoichiometric air-fuel ratio, so that NOx, unburned HC, CO, and the like in the exhaust gas are purified. However, when the oxygen storage amount of the exhaust gas control catalyst 44 becomes almost zero, oxygen cannot be released from the exhaust gas control catalyst 44 anymore, and thus, unburned HC, CO and the like in the exhaust gas cannot be purified.

The control device 50 includes an electronic control unit (ECU) 51 and various sensors). ECU 51 includes a processor that performs various processes, and memories that store programs executed by the processor and various types of data. The control device 50 includes, as various sensors, for example, an air amount sensor 52 that detects an amount of intake air to the internal combustion engine 1, a temperature sensor 53 that detects a temperature of the exhaust gas control catalyst 44, and a downstream air-fuel ratio sensor 54 that detects an air-fuel ratio of the exhaust gas flowing into the reactor 45, and these sensors are connected to ECU 51. In addition, the control device 50 includes, as various sensors, for example, a load sensor 55 for detecting a load of the internal combustion engine 1 and a crank angle sensor 56 used for detecting an engine rotational speed, and these sensors are also connected to ECU 51. ECU 51 is connected to actuators for controlling the operation of the internal combustion engine 1. In the embodiment shown in FIG. 1, ECU 51 is connected to and controls the fuel injection valve 21, the fuel pump 24 and the throttle valve drive actuator 37.

Configuration of the Electrochemical Reactor

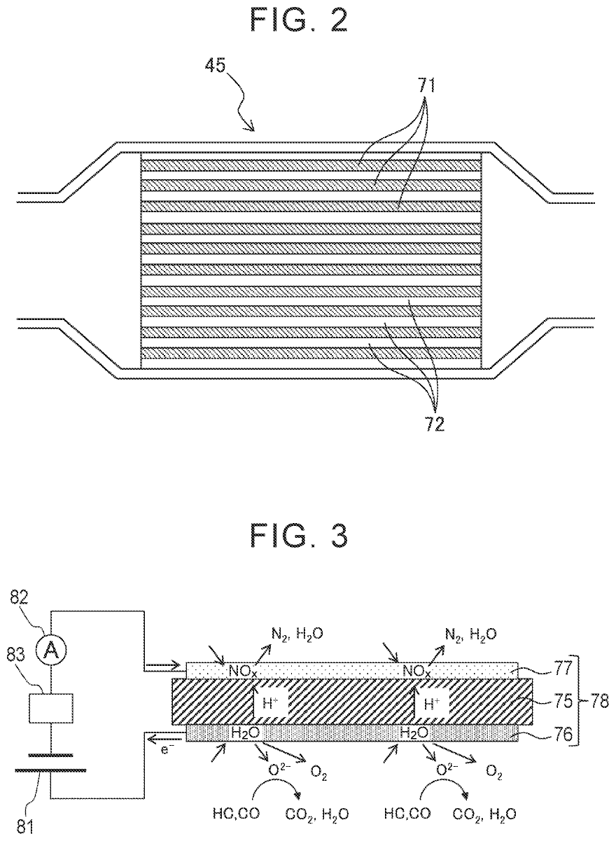

Next, with reference to FIGS. 2 and 3, the configuration of the reactor 45 according to the present embodiment will be described. FIG. 2 is a cross-sectional side view of reactor 45. As shown in FIG. 2, the reactor 45 includes a partition wall 71 and a passage 72 defined by the partition wall. The partition wall 71 includes a plurality of first partition walls extending parallel to each other, and a plurality of second partition walls extending perpendicular to the first partition walls and parallel to each other. The passage 72 is defined by the first and second septums and extends parallel to each other. Therefore, the reactor 45 according to the present embodiment has a honeycomb structure. The exhaust gas flowing into the reactor 45 flows through the plurality of passages 72. Note that the partition wall 71 may be formed only from a plurality of partition walls extending in parallel to each other, and may be formed so as not to include a partition wall perpendicular to the plurality of partition walls.

FIG. 3 is an enlarged cross-sectional view of the partition wall 71 of the reactor 45. As shown in FIG. 3, the partition wall 71 of the reactor 45 includes a solid electrolyte layer 75, an anode layer 76 disposed on one surface of the solid electrolyte layer 75, and a cathode layer 77 disposed on the surface of the solid electrolyte layer 75 opposite the surface on which the anode layer 76 is disposed. The solid electrolyte layer 75, the anode layer 76, and the cathode layer 77 form a cell 78. Each passage 72 of exhaust gas is exposed to an anode layer 76 of at least one cell 78 and a cathode layer 77 of at least one other cell 78.

The solid electrolyte layer 75 includes a porous solid electrolyte having proton conductivity. As a solid-state electrolyte, for example, a perovskite-type metal oxide MM′₁₋ₓRₓO_{3-α}(M=Ba, Sr, Ca, M′=Ce, Zr, R=Y, Yb, for example, SrZrₓYb₁₋ₓO_{3-α}, SrCeO₃, BaCeO₃, CaZrO₃, SrZrO₃, a phosphate (e.g., SiO₂—P₂O₅ glasses), and a metal dope SnₓIn₁₋ₓP₂O₇ (e.g., SnP₂O₇) or zeolites (e.g., ZSM-5) are used.

Both the anode layer 76 and the cathode layer 77 comprise a noble metal such as Pt, Pd or Rh. In addition, the anode layer 76 includes a substance (water molecule holding material) capable of holding water molecules (i.e., capable of adsorption and/or absorption). Specific examples of the substance capable of holding water molecules include zeolite, silica gel, and activated alumina.

On the other hand, the cathode layers 77 include materials (NOx retainers) capable of retaining (i.e., adsorbing and/or absorbing) NOx. Specific examples of the material capable of holding NOx include alkali metals such as K and Na, alkaline earth metals such as Ba, and rare earths such as La.

Further, the internal combustion engine 1 includes a power supply device 81, an ammeter 82, and a voltage regulating device 83. The positive electrode of the power supply device 81 is connected to the anode layer 76, and the negative electrode of the power supply device 81 is connected to the cathode layer 77. The voltage regulating device 83 is configured to be able to change the voltage applied between the anode layer 76 and the cathode layer 77. The voltage regulating device 83 is configured to change the magnitude of the current supplied to the reactor 45 so as to flow from the anode layer 76 to the cathode layer 77 through the solid electrolyte layer 75.

The power supply device 81 is connected in series with the ammeter 82. The ammeter 82 is connected to ECU 51. The voltage regulating device 83 is connected to ECU 51 and controlled by ECU 51. Therefore, the voltage regulating device 83 and ECU 51 function as an energization control unit that controls the magnitude of the voltage applied between the anode layer 76 and the cathode layer 77 (that is, energization of the reactor 45).

In the reactor 45 configured as described above, when a current flows from the power supply device 81 to the anode layer 76 and the cathode layer 77, the anode layer 76 and the cathode layer 77 react as shown in the following equations.

Anode-side:2H₂O→4H⁺+O₂+4e⁻

H₂O→2H⁺+O²⁻

Cathode: 2NO+4H⁺+4e⁻→N₂+2H₂O

That is, in the anode layer 76, the water molecules held in the anode layer 76 are electrolyzed to generate oxygen and oxygen ions and protons. The generated oxygen is released into the exhaust gas, and the generated protons migrate through the solid electrolyte layer 75 from the anode layer 76 to the cathode layer 77. In the cathode layer 77, NO held in the cathode layer 77 reacts with protons and electrons to form nitrogen and water molecules.

Therefore, according to the present embodiment, NO held by NOx holding material of the cathode layer 77 can be reduced and purified to N₂ by supplying a current from the power supply device 81 of the reactor 45 to the anode layer 76 and the cathode layer 77 (that is, by energizing the reactor 45).

When unburned HC or CO is contained in the exhaust gas in the anode layer 76, oxygen ions react with HC or CO to generate carbon dioxide or water. Since the unburned HC contains various components, it is expressed as CₘHₙ in the following equation. Therefore, according to the present embodiment, it is also possible to oxidize and purify HC and CO in the exhaust gases by supplying current from the power supply device 81 of the reactor 45 to the anode layer 76 and the cathode layer 77.

CₘHₙ+(2m+0.5n)O²⁻→mCO₂+0.5nH₂O+(4m+n)e⁻

CO+O²⁻→CO₂+2e⁻

Therefore, in the present embodiment, when the reactor 45 is energized, it is possible to purify NOx, HC and CO, which are components to be purified in the exhaust gases.

The anode layers 76 may also include materials (HC retainers) capable of retaining (i.e., adsorbing and/or absorbing) unburned HC. Specific examples of the material capable of holding HC include zeolites. If the anode layer 76 contains a material capable of holding HC, the oxygen-ion reacts with HC being held and is purified.

In the above embodiment, the anode layer 76 and the cathode layer 77 are disposed on two surfaces opposite to the solid electrolyte layer 75. However, the anode layer 76 and the cathode layer 77 may be disposed on the same surface of the solid electrolyte layer 75. In this case, the protons move in the vicinity of the surface of the solid electrolyte layer 75 in which the anode layer 76 and the cathode layer 77 are disposed.

In the present embodiment, the solid electrolyte layer 75 of the reactor 45 includes a proton-conductive solid electrolyte. However, the solid electrolyte layer 75 may be configured to include other ion-conductive solid electrolytes, such as an oxygen ion-conductive solid electrolyte, instead of a proton-conductive solid electrolyte. In addition, the reactor 45 may be a reactor of another aspect as long as the unburned HC, CO or NOx can be purified by energization.

Control of Electrochemical Reactors

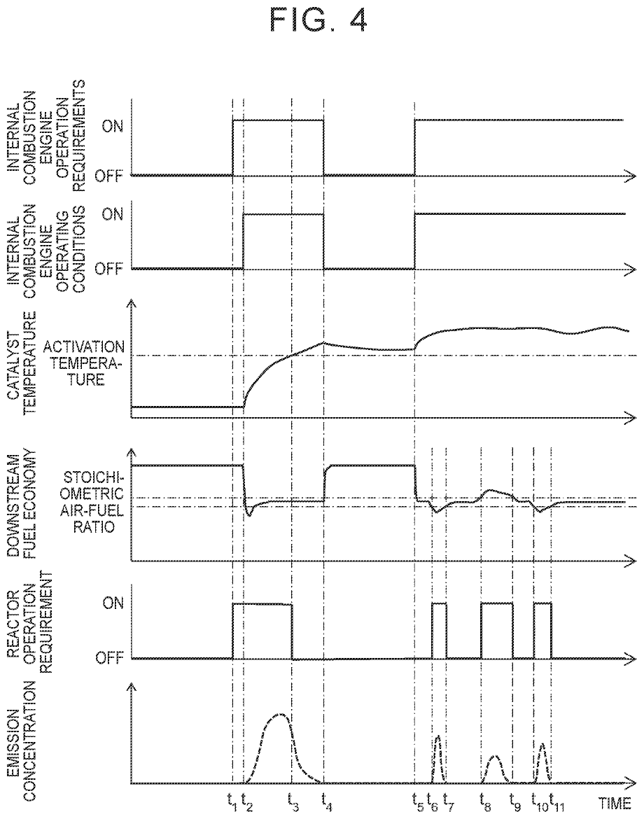

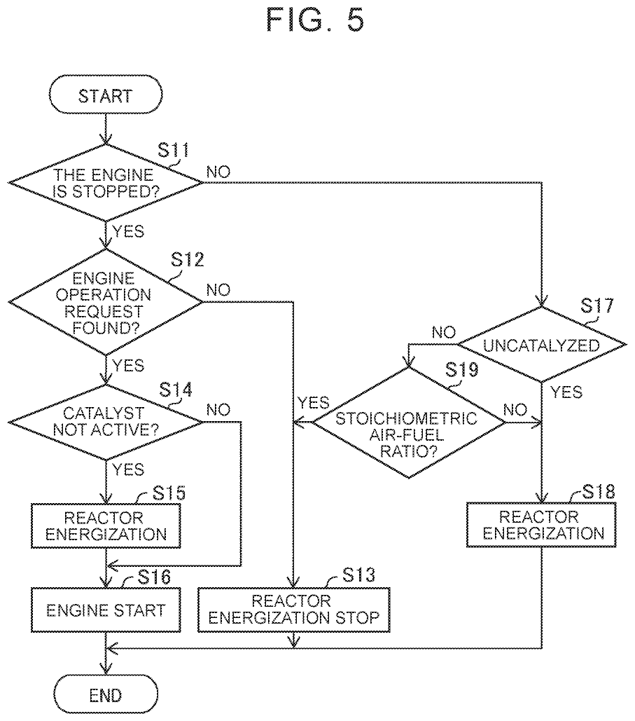

Next, the control of the operation of the reactor 45 will be described with reference to FIGS. 4 and 5.

When the temperature of the exhaust gas control catalyst 44 becomes equal to or higher than the activation temperature, it is basically possible to sufficiently purify components to be purified such as NOx, HC, CO in the exhaust gas. On the other hand, when the temperature of the exhaust gas control catalyst 44 is lower than the activation temperature, the component to be purified in the exhaust gas cannot be sufficiently purified. Further, even if the temperature of the exhaust gas control catalyst 44 is equal to or higher than the activation temperature, if, for example, the oxygen storage amount of the exhaust gas control catalyst 44 is substantially zero or is substantially the maximum storable oxygen amount, it is not possible to sufficiently purify the purification target component in the exhaust gas.

On the other hand, the reactor 45 can purify the component to be purified in the exhaust gas by energizing. However, in order to purify the component to be purified in the reactor 45, it is necessary to energize the component, so that power is consumed. Therefore, from the viewpoint of reducing the power consumption in the reactor 45, it is preferable that the energization time to the reactor 45 is as short as possible.

Therefore, in the present embodiment, the energization to the reactor 45 is controlled based on the active parameter representing the active state of the exhaust gas control catalyst 44 and the air-fuel ratio parameter related to the air-fuel ratio of the inflow exhaust gas flowing into the reactor 45. Specifically, when the activity parameter is a value indicating that the exhaust gas control catalyst 44 is active and the air-fuel ratio parameter is a value indicating that the air-fuel ratio of the inflowing exhaust gas is an air-fuel ratio different from the stoichiometric air-fuel ratio, energization to the reactor 45 is performed. Further, when the activity parameter is a value indicating that the exhaust gas control catalyst 44 is active and the air-fuel ratio parameter is a value indicating that the air-fuel ratio of the inflowing exhaust gas is a stoichiometric air-fuel ratio, energization to the reactor 45 is not performed. On the other hand, when the activity parameter is a value indicating that the exhaust gas control catalyst 44 is not active, the reactor 45 is energized regardless of the value of the air-fuel ratio parameter.

FIG. 4 is a time chart of various parameters when the operation of the reactor 45 according to the first embodiment is controlled. The operation request of the internal combustion engine 1 in FIG. 4 represents a case where the operation of the internal combustion engine 1 is required in the case of ON, and a case where the operation of the internal combustion engine 1 is not required in the case of OFF. The operation requirement of the internal combustion engine 1 is outputted, for example, in an ECU 51. In the ECU 51, the operation request is ON, for example, when the ignition switch is turned ON, when the depression amount of the brake pedal becomes zero, when the charge rate of the battery becomes equal to or lower than a predetermined value in hybrid electric vehicle, or the like. Further, the operating condition of the internal combustion engine 1 in FIG. 4 indicates when the internal combustion engine 1 is operated (when the crankshaft is rotated) in ON state and when the internal combustion engine 1 is stopped (when the crankshaft is stopped) in OFF state.

The catalyst temperature in FIG. 4 represents the temperature of the exhaust gas control catalyst 44, and in the present embodiment, represents the temperature detected by the temperature sensor 53. The downstream air-fuel ratio represents the air-fuel ratio of the exhaust gas on the downstream side of the exhaust gas control catalyst 44, that is, the inflow exhaust gas flowing into the reactor 45, and represents the air-fuel ratio detected by the downstream air-fuel ratio sensor 54 in the present embodiment. In particular, the two dashed-dotted lines in the figure represent a range in which the air-fuel ratio of the inflow exhaust gas is determined to be the stoichiometric air-fuel ratio (for example, a range of 14.4 to 14.8 when the actual stoichiometric air-fuel ratio is 14.6). In the present embodiment, the internal combustion engine 1 is controlled so that the air-fuel ratio of the exhaust gas discharged from the engine main body 10 becomes the stoichiometric air-fuel ratio.

In addition, the operation request of the reactor 45 in FIG. 4 represents a time when the operation of the reactor 45 is required in the case of ON, and a time when the operation of the reactor 45 is not required in the case of OFF. When the operation of the reactor 45 is requested, the power supply to the reactor 45 is performed, and when the operation of the reactor 45 is not requested, the power supply to the reactor 45 is stopped. The emission concentration represents the concentration of the emission in the exhaust gas flowing out of the reactor 45, specifically, the concentration of the components to be purified such as NOx, HC, CO in the exhaust gas. In FIG. 4, the emission concentration when the reactor 45 is used is indicated by a solid line, and the emission concentration when the reactor 45 is not used is indicated by a broken line.

In the embodiment shown in FIG. 4, the operation of the internal combustion engine 1 is required at the time t₁ while the internal combustion engine 1 is cold. Since the temperature of the exhaust gas control catalyst 44 is lower than the activation temperature at the time t₁, the exhaust gas purification capacity of the exhaust gas control catalyst 44 is insufficient at the time t₁. For this reason, in order to appropriately purify the exhaust gases, the operation of the reactor 45 is required at a time t₁ at which the operation of the internal combustion engine 1 is required.

When the operation of the reactor 45 is requested and the energization of the reactor 45 is started, then the operation of the internal combustion engine 1 is started at the time t₂. That is, in the present embodiment, the operation of the internal combustion engine 1 is started after the energization of the reactor 45 is started. As a result, even immediately after the start of the operation of the internal combustion engine 1, the component to be purified in the exhaust gas can be sufficiently purified by the reactor 45.

Thereafter, while the temperature of the exhaust gas control catalyst 44 is lower than the activation temperature, the power supply to the reactor 45 is continued. As a result, even if the exhaust gas containing the component to be purified flows out from the exhaust gas control catalyst 44, the component to be purified is purified by the reactor 45. When the temperature of the exhaust gas control catalyst 44 becomes equal to or higher than the activation temperature at the time t₃, the operation request of the reactor 45 is stopped, and thus the energization of the reactor 45 is stopped. However, since the temperature of the exhaust gas control catalyst 44 is equal to or higher than the activation temperature, the components to be purified in the exhaust gas are purified by the exhaust gas control catalyst 44, and therefore, the concentration of the emission in the exhaust gas flowing out from the reactor 45 is maintained at almost zero even after the time t₃ at which the energization to the reactor 45 is stopped.

In the embodiment shown in FIG. 4, the operation of the internal combustion engine 1 is subsequently stopped at the time t₄, and the operation of the internal combustion engine 1 is stopped after the time t₄. As a result, the temperature of the exhaust gas control catalyst 44 gradually decreases, and since air flows into the exhaust pipe 42, the air-fuel ratio of the gas in the exhaust pipe 42 becomes a lean air-fuel ratio.

Thereafter, in the embodiment shown in FIG. 4, the operation of the internal combustion engine 1 is requested again at the time t₅, and the operation of the internal combustion engine 1 is started. At this time, since the temperature of the exhaust gas control catalyst 44 is equal to or higher than the activation temperature and the air-fuel ratio of the exhaust gas is substantially the stoichiometric air-fuel ratio, the operation request of the reactor 45 is maintained while being stopped.

At time t₆, when the temperature of the exhaust gas control catalyst 44 is equal to or higher than the activation temperature and the air-fuel ratio of the inflow exhaust gas discharged from the exhaust gas control catalyst 44 and flowing into the reactor 45 is not in the vicinity of the stoichiometric air-fuel ratio, the operation of the reactor 45 is required, and the reactor 45 is energized. When the air-fuel ratio of the inflow exhaust gas is not in the vicinity of the stoichiometric air-fuel ratio, the inflow exhaust gas contains the purification target component, and the purification target component is purified in the reactor 45. Therefore, even when the air-fuel ratio of the inflow exhaust gas is not in the vicinity of the stoichiometric air-fuel ratio, the concentration of the emission in the exhaust gas flowing out of the reactor 45 can be kept low.

Thereafter, at time t₇, when the air-fuel ratio of the inflowing exhaust gas becomes substantially the stoichiometric air-fuel ratio, the operation demand of the reactor 45 is stopped, and the energization of the reactor 45 is stopped. Since the air-fuel ratio of the inflow exhaust gas is substantially the stoichiometric air-fuel ratio, almost no component to be purified is contained in the exhaust gas flowing out of the exhaust gas control catalyst 44, and therefore, even if the energization to the reactor 45 is stopped, almost no component to be purified is contained in the exhaust gas flowing out of the reactor 45. Further, by stopping the energization of the reactor 45, it is possible to suppress the consumption of electric power in the internal combustion engine 1.

In the embodiment illustrated in FIG. 4, similarly, the air-fuel ratio of the inflow exhaust gas is not in the vicinity of the stoichiometric air-fuel ratio even at times t₈ and t₁₀, so that the reactor 45 is energized. Then, when the air-fuel ratio of the inflow exhaust gas becomes substantially the stoichiometric air-fuel ratio at time t₉ and time t₁₁, the energization of the reactor 45 is stopped.

As described above, in the present embodiment, the energization of the reactor 45 is controlled based on the active state of the exhaust gas control catalyst 44 and the air-fuel ratio of the exhaust gas flowing into the reactor 45. As a result, it is possible to detect when the exhaust gas control catalyst 44 cannot sufficiently purify the purification target component, and thus it is possible to suppress the purification target component from flowing out of the exhaust gas control apparatus during the operation of the internal combustion engine 1. In particular, in the present embodiment, even if the temperature of the exhaust gas control catalyst 44 is equal to or higher than the activation temperature, when the air-fuel ratio of the inflow exhaust gas is an air-fuel ratio (an air-fuel ratio that is not in the vicinity of the stoichiometric air-fuel ratio) different from the stoichiometric air-fuel ratio, the reactor 45 is energized. Even if the temperature of the exhaust gas control catalyst 44 is equal to or higher than the activation temperature, for example, in the case where the oxygen storage amount is substantially zero or substantially the maximum storable oxygen amount, the exhaust gas containing the purification target component flows out from the exhaust gas control catalyst 44, and even in such a case, it is possible to suppress the purification target component from flowing out from the exhaust gas control apparatus. Further, in the present embodiment, when the temperature of the exhaust gas control catalyst 44 is equal to or higher than the activation temperature and the air-fuel ratio of the inflowing exhaust gas is the stoichiometric air-fuel ratio (approximately the stoichiometric air-fuel ratio), the reactor 45 is not energized. In such a case, since the component to be purified is almost purified in the exhaust gas control catalyst 44, it is possible to suppress the component to be purified from flowing out of the exhaust gas control apparatus, and it is possible to suppress the consumption of unnecessary power accompanying the energization to the reactor 45. On the other hand, in the present embodiment, when the temperature of the exhaust gas control catalyst 44 is lower than the activation temperature, the reactor 45 is energized. In such a case, the component to be purified is not sufficiently purified by the exhaust gas control catalyst 44, and the component to be purified can be purified by the reactor 45. Therefore, it is possible to suppress the component to be purified from flowing out of the exhaust gas control apparatus.

In the above-described embodiment, the air-fuel ratio detected by the downstream air-fuel ratio sensor 54 that detects the air-fuel ratio of the inflow exhaust gas is used as the air-fuel ratio parameter related to the air-fuel ratio of the inflow exhaust gas flowing into the reactor 45. Therefore, the air-fuel ratio of the inflow exhaust gas can be accurately detected. Further, in the above-described embodiment, the temperature of the exhaust gas control catalyst 44 detected by the temperature sensor 53 is used as an active parameter indicating the active state of the exhaust gas control catalyst 44. Therefore, the active state of the exhaust gas control catalyst 44 can be estimated without delay.

In the above-described embodiment, whether or not the exhaust gas control catalyst 44 is active is determined based on the temperature of the exhaust gas control catalyst 44. However, whether or not the exhaust gas control catalyst 44 is active may be determined based on other activity parameters representing the active state of the exhaust gas control catalyst 44.

Specifically, for example, a NOx sensor (not shown) that detects NOx level in the exhaust gas flowing out of the exhaust gas control catalyst 44 and flowing into the reactor 45 may be provided in the exhaust pipe 42 downstream of the exhaust gas control catalyst 44 and upstream of the reactor 45. NOx density detected by NOx sensor may be used as the activity parameter. In this case, since NOx concentration in the exhaust gas is high when the exhaust gas control catalyst 44 is not activated regardless of the air-fuel ratio of the exhaust gas, it is determined that the exhaust gas control catalyst 44 is not activated when NOx concentration in the exhaust gas is equal to or more than a predetermined reference value.

Alternatively, a parameter calculated based on NOx density detected by NOx sensor may be used as the activity parameter. Specifically, for example, the ratio of NOx concentration detected by NOx sensor to the discharge concentration of NOx from the engine main body 10, that is, NOx purification rate in the exhaust gas control catalyst 44 may be used as the activity parameter. In this case, the emission density of NOx from the engine main body 10 is calculated based on, for example, the operating condition of the internal combustion engine 1. Specifically, the emission density of NOx from the engine main body 10 is calculated based on, for example, the engine rotational speed calculated based on the load of the internal combustion engine 1 detected by the load sensor 55 and the power of the crank angle sensor 56. In this case, when the calculated NOx purification rate is equal to or less than the predetermined reference value, it is determined that the exhaust gas control catalyst 44 is not active.

As described above, by using the parameter calculated based on NOx concentration or NOx concentration as the active parameter, it is possible to accurately estimate whether or not the exhaust gas control catalyst 44 is active, although there is some delay.

FIG. 5 is a flow chart of a control routine of the operation of the reactor 45. The illustrated control routines are executed at regular intervals in ECU 51.

First, ECU 51 determines whether or not the internal combustion engine 1 is stopped (step S11). Whether or not the internal combustion engine 1 is stopped is determined based on, for example, the rotational speed of the crankshaft of the engine main body 10. When it is determined in step S11 that the internal combustion engine 1 is not stopped, ECU 51 determines whether or not the operation of the internal combustion engine 1 is requested (step S12). When it is determined in step S12 that the operation of the internal combustion engine 1 is not required, the energization of the reactor 45 is stopped (step S13).

On the other hand, when it is determined in step S12 that the operation of the internal combustion engine 1 is requested, ECU 51 determines whether the exhaust gas control catalyst 44 is not active, that is, whether the temperature of the exhaust gas control catalyst 44 detected by the temperature sensor 53 is less than the active temperature (step S14). When it is determined that the exhaust gas control catalyst 44 is not activated in the step S14, the reactor 45 is energized (step S15), and thereafter, the operation of the internal combustion engine 1 is started (step S16). On the other hand, when it is determined that the exhaust gas control catalyst 44 is active in the step S14, the operation of the internal combustion engine 1 is started without energizing the reactor 45 (step S16).

When the operation of the internal combustion engine 1 is started, it is determined in the subsequent control routine that the internal combustion engine 1 is not stopped in the step S11. If it is determined in step S11 that the internal combustion engine 1 is not stopped, ECU 51 determines whether or not the exhaust gas control catalyst 44 is not activated (step S17). When it is determined in the step S17 that the exhaust gas control catalyst 44 is not active, the reactor 45 is energized (step S18).

On the other hand, if it is determined in step S17 that the exhaust gas control catalyst 44 is active, ECU 51 determines whether or not the air-fuel ratio detected by the downstream air-fuel ratio sensor 54 is substantially the stoichiometric air-fuel ratio (step S19). When it is determined that the air-fuel ratio detected by the downstream air-fuel ratio sensor 54 in the step S19 is substantially the stoichiometric air-fuel ratio, energization to the reactor 45 is stopped (step S13). On the other hand, when it is determined in the step S19 that the air-fuel ratio detected by the downstream air-fuel ratio sensor 54 is not in the vicinity of the stoichiometric air-fuel ratio, the reactor 45 is energized (step S18).

### Second Embodiment

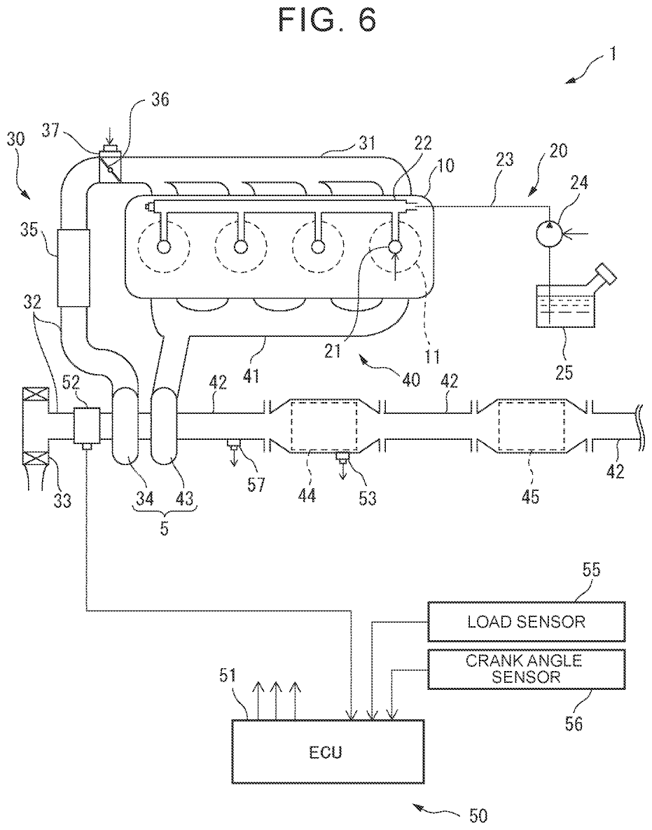

Next, an exhaust gas control apparatus according to a second embodiment will be described with reference to FIGS. 6 to 10. The configuration and control of the exhaust gas control apparatus according to the second embodiment are basically the same as the configuration and control of the exhaust gas control apparatus according to the first embodiment. Hereinafter, a portion different from the exhaust gas control apparatus according to the first embodiment will be mainly described.

In the first embodiment, the air-fuel ratio of the exhaust gas detected by the downstream air-fuel ratio sensor 54 is used as the air-fuel ratio parameter related to the air-fuel ratio of the inflow exhaust gas flowing into the reactor 45. On the other hand, in the second embodiment, the oxygen storage amount of the exhaust gas control catalyst 44 is used as the air-fuel ratio parameter.

Here, as described above, when the oxygen storage amount of the exhaust gas control catalyst 44 is between zero and the maximum storable oxygen amount, it is possible to purify the purification target component in the exhaust gas. Therefore, in this case, the air-fuel ratio of the inflowing exhaust gas flowing into the reactor 45 is approximately the stoichiometric air-fuel ratio. On the other hand, when the oxygen storage amount of the exhaust gas control catalyst 44 is zero, the unburned HC, CO and the like cannot be purified, and therefore, there is a possibility that the air-fuel ratio of the inflow exhaust gas becomes a rich air-fuel ratio. In addition, when the oxygen storage amount of the exhaust gas control catalyst 44 is the maximum storable oxygen amount, oxygen cannot be stored, and therefore, there is a possibility that the air-fuel ratio of the inflowing exhaust gas becomes the lean air-fuel ratio. Along with this, the incoming exhaust gases may contain NOx. Therefore, it can be said that the oxygen storage amount of the exhaust gas control catalyst 44 is an air-fuel ratio parameter related to the air-fuel ratio of the inflow exhaust gas flowing into the reactor 45.

In the present embodiment, when the activity parameter is a value indicating that the exhaust gas control catalyst 44 is active and the oxygen storage amount of the exhaust gas control catalyst 44 is zero or the maximum storable oxygen amount (including approximately zero or approximately the maximum storable oxygen amount), the reactor 45 is energized. On the other hand, when the activity parameter is a value indicating that the exhaust gas control catalyst 44 is active and the oxygen storage amount of the exhaust gas control catalyst 44 is not zero or the maximum storable oxygen amount (including approximately zero or approximately the maximum storable oxygen amount), the power supply to the reactor 45 is not performed.

FIG. 6 is a schematic configuration diagram of the internal combustion engine 1 in which the exhaust gas control apparatus according to the second embodiment is mounted. As shown in FIG. 6, in the present embodiment, the downstream side air-fuel ratio sensor is not provided on the downstream side of the exhaust gas control catalyst 44. Instead, in the present embodiment, an upstream air-fuel ratio sensor 57 for detecting the air-fuel ratio of the exhaust gas flowing into the exhaust gas control catalyst 44 is provided in the exhaust pipe 42 upstream of the exhaust gas control catalyst 44.

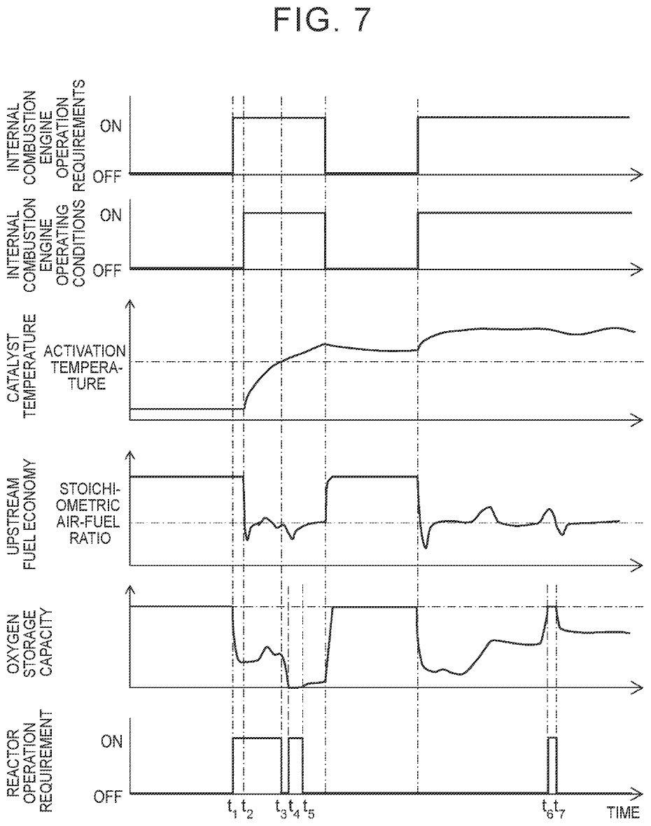

FIG. 7 is a time chart of various parameters when the operation of the reactor 45 according to the second embodiment is controlled. The upstream air-fuel ratio represents the air-fuel ratio of the exhaust gas upstream of the exhaust gas control catalyst 44, that is, the exhaust gas flowing into the exhaust gas control catalyst 44, and represents the air-fuel ratio detected by the upstream air-fuel ratio sensor 57 in the present embodiment. In particular, in FIG. 7, the stoichiometric air-fuel ratio is indicated by a dashed-dotted line.

The oxygen storage amount in FIG. 7 represents the oxygen storage amount in the exhaust gas control catalyst 44. The oxygen storage amount OSA in the exhaust gas control catalyst 44 is calculated, for example, by the following equation (1) based on the air-fuel ratio AFup of the exhaust gas detected by the upstream air-fuel ratio sensor 57 and the intake air amount Ga detected by the air amount sensor 52.

OSA=Σ(Kdosa×Ga×(AFup−AFst)/AFup (1)

In the above equation (1), Kdosa is the storage efficiency factor, and AFst is the stoichiometric air-fuel ratio (e.g., 14.6).

In the example shown in FIG. 7, similarly to the example shown in FIG. 4, the operation of the internal combustion engine 1 is requested at the time t₁, the operation of the internal combustion engine 1 is started at the time t₂, and at the time t₃, the temperature of the exhaust gas control catalyst 44 becomes equal to or higher than the activation temperature, and the energization of the reactor 45 is stopped.

In the example shown in FIG. 7, when the oxygen storage amount of the exhaust gas control catalyst 44 becomes substantially zero at time t₄ while the temperature of the exhaust gas control catalyst 44 is equal to or higher than the activation temperature, the operation of the reactor 45 is requested, and the energization of the reactor 45 is started. When the oxygen storage amount of the exhaust gas control catalyst 44 becomes almost zero, there is a possibility that unburned HC or CO or the like flows out from the exhaust gas control catalyst 44, and even if unburned HC or CO or the like flows out by energizing the reactor 45, it is purified in the reactor 45. Thereafter, when the oxygen storage amount of the exhaust gas control catalyst 44 is not near zero at the time t₅, the operation demand of the reactor 45 is stopped and the power supply to the reactor 45 is stopped.

Further, in the embodiment shown in FIG. 7, at time t₆, when the oxygen storage amount of the exhaust gas control catalyst 44 becomes substantially the maximum storable oxygen amount while the temperature of the exhaust gas control catalyst 44 is equal to or higher than the activation temperature, the operation of the reactor 45 is requested, and the power supply to the reactor 45 is started. When the oxygen storage amount of the exhaust gas control catalyst 44 becomes substantially the largest storable oxygen amount, there is a possibility that NOx or the like flows out from the exhaust gas control catalyst 44, even if NOx or the like flows out by energizing the reactor 45 is purified in the reactor 45. Thereafter, when the oxygen storage amount of the exhaust gas control catalyst 44 is not in the vicinity of the maximum storable oxygen amount at the time t₇, the operation request of the reactor 45 is stopped, and the power supply to the reactor 45 is stopped. In the present embodiment, the maximum storable oxygen amount is set to a predetermined constant value in accordance with the type of the exhaust gas control catalyst 44.

As described above, in the present embodiment, the energization of the reactor 45 is controlled based on the oxygen storage amount of the exhaust gas control catalyst 44. When the energization of the reactor 45 is controlled based on the output of the downstream air-fuel ratio sensor 54 as in the first embodiment, the energization of the reactor 45 is started after the exhaust gas having the rich air-fuel ratio or the lean air-fuel ratio flows out from the exhaust gas control catalyst 44. On the other hand, when the energization of the reactor 45 is controlled based on the oxygen storage amount of the exhaust gas control catalyst 44 as in the present embodiment, it is possible to start the energization of the reactor 45 when or before the exhaust gas of the rich air-fuel ratio or the lean air-fuel ratio flows out from the exhaust gas control catalyst 44, and thus it is possible to suppress the flow of the purification target component from the exhaust gas control apparatus.

In particular, in the present embodiment, even if the temperature of the exhaust gas control catalyst 44 is equal to or higher than the activation temperature, when the oxygen storage amount of the exhaust gas control catalyst 44 is zero or the maximum storable oxygen amount, energization of the reactor 45 is performed. As a result, it is possible to suppress the component to be purified from flowing out of the exhaust gas control apparatus. Further, when the temperature of the exhaust gas control catalyst 44 is equal to or higher than the activation temperature and the oxygen storage amount of the exhaust gas control catalyst 44 is not zero or the maximum storable oxygen amount, the power supply to the reactor 45 is not performed. In such a case, since the component to be purified is almost purified in the exhaust gas control catalyst 44, it is possible to suppress the component to be purified from flowing out of the exhaust gas control apparatus, and it is possible to suppress the consumption of unnecessary power accompanying the energization to the reactor 45.

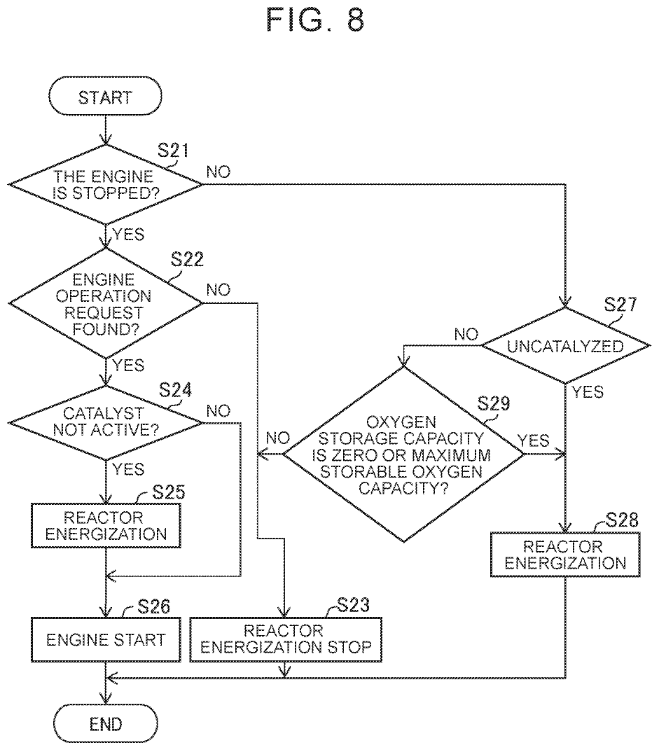

FIG. 8 is a flowchart of a control routine for the operation of the reactor 45 according to the second embodiment. The illustrated control routines are executed at regular intervals in ECU 51. S28 from the step S21 is the same as S18 from the step S11 in FIG. 5, and therefore will not be described.

When it is determined in step S27 that the exhaust gas control catalyst 44 is active, ECU51 determines whether the oxygen storage amount of the exhaust gas control catalyst 44 calculated based on the outputs of the upstream air-fuel ratio sensor 57 and the air amount sensor 52 is zero or the maximum storable oxygen amount (step S29). When it is determined in the step S29 that the oxygen storage amount is not zero or the maximum storable oxygen amount, the power supply to the reactor 45 is stopped (step S23). On the other hand, when it is determined in the step S29 that the oxygen storage amount is zero or the maximum storable oxygen amount, the reactor 45 is energized (step S28).

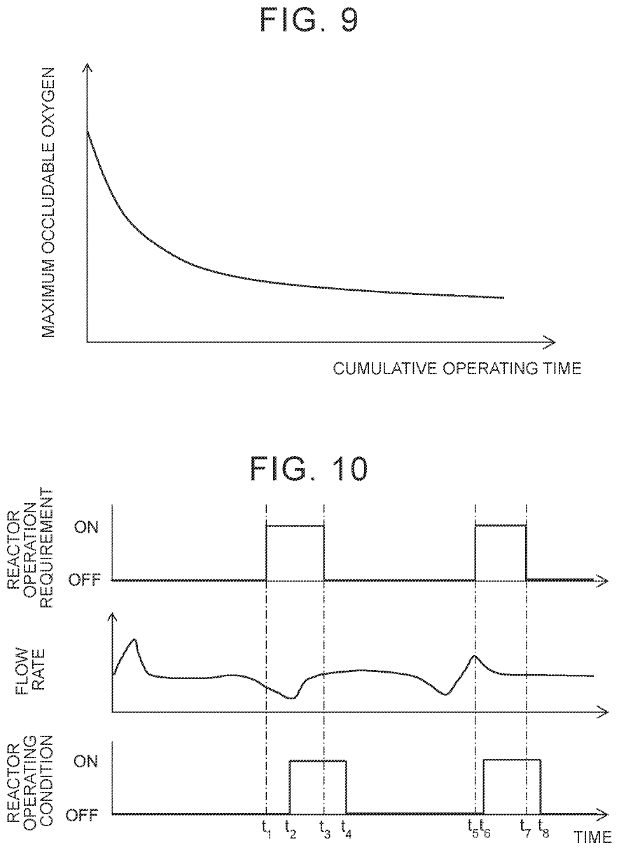

In the second embodiment, the maximum storable oxygen amount of the exhaust gas control catalyst 44 is set to a predetermined constant value in accordance with the type of the exhaust gas control catalyst 44. However, the maximum storable oxygen amount gradually decreases according to the operation time of the internal combustion engine 1 due to deterioration. Therefore, the maximum storable oxygen amount may be calculated based on the cumulative operation time of the internal combustion engine 1. In this case, as illustrated in FIG. 9, the maximum storable oxygen amount is set to a smaller amount as the cumulative operation time of the internal combustion engine 1 becomes longer.

Further, in the second embodiment, the operation of the reactor 45 is required as soon as the oxygen storage amount of the exhaust gas control catalyst 44 becomes zero or the maximum storable oxygen amount, and the power supply to the reactor 45 is performed as soon as the operation of the reactor 45 is required. However, since the exhaust gas control catalyst 44 is separated from the reactor 45, the oxygen storage amount of the exhaust gas control catalyst 44 becomes zero or the maximum storable oxygen amount, the purification target component does not flow into the reactor 45 immediately, after some time has elapsed, the purification target component flows into the reactor 45. Further, in the second embodiment, as soon as the oxygen storage amount of the exhaust gas control catalyst 44 is not zero or the maximum storable oxygen amount, the operation request of the reactor 45 is stopped, and the energization of the reactor 45 is stopped. However, since the exhaust gas control catalyst 44 is separated from the reactor 45, the oxygen storage amount of the exhaust gas control catalyst 44 is not zero or the maximum storable oxygen amount, the purification target component does not immediately flow into the reactor 45, the purification target component does not flow into the reactor 45 after some time has elapsed.

Therefore, ECU 51 may energize the reactor 45 after a predetermined period of time has elapsed since the oxygen storage amount of the exhaust gas control catalyst 44 reaches zero or the maximum storable oxygen amount. Further, the predetermined time at this time may be a fixed time, or may be set to be shorter than when the flow rate of the exhaust gas discharged from the engine main body 10 is high than when the flow rate is low. In particular, the predetermined time is set to be shorter as the flow rate of the exhaust gas discharged from the engine main body 10 increases. Similarly, ECU 51 may shut down the energization of the reactor 45 after a predetermined period of time has elapsed since the oxygen storage amount of the exhaust gas control catalyst 44 is no longer zero or the maximum storable oxygen amount. Further, the predetermined time at this time may be a fixed time, or may be set to be shorter than when the flow rate of the exhaust gas discharged from the engine main body 10 is high than when the flow rate is low. In particular, the predetermined time is set to be shorter as the flow rate of the exhaust gas discharged from the engine main body 10 increases.

FIG. 10 is a time chart of an operation request of the reactor 45, a flow rate of the exhaust gas, and an operation state of the reactor 45. The flow rate of the exhaust gas is calculated based on, for example, the load of the internal combustion engine 1 detected by the load sensor 55 and the engine rotation speed calculated based on the output of the crank angle sensor 56.

As can be seen from FIG. 10, when the flow rate of the exhaust gas is slow, the time from when the operation of the reactor 45 is required to when the reactor 45 is actually operated is long. On the other hand, when the flow rate of the exhaust gas is high, the time from when the operation of the reactor 45 is requested to when the reactor 45 is actually operated is short. The time at this time is, for example, a time obtained by dividing the length of the exhaust pipe 42 from the exhaust gas control catalyst 44 to the reactor 45 (or the length of the exhaust pipe 42 from the engine main body 10 to the reactor 45) by the calculated flow rate of the exhaust gas.

By controlling the energization of the reactor 45 after a predetermined time has elapsed since the oxygen storage amount of the exhaust gas control catalyst 44 has changed in this way, it is not energized to the reactor 45 when the component to be purified has not yet flowed into the reactor 45, the component to be purified is still flowing into the reactor 45 It is not to stop the energization to the reactor 45. Therefore, it is possible to suppress unnecessary power consumption due to the energization of the reactor 45, and it is possible to suppress the outflow of the component to be purified from the exhaust gas control apparatus.

Although the preferred embodiments of the present disclosure have been described above, the present disclosure is not limited to these embodiments, and various modifications and alterations can be made within the scope of the claims.

What is claimed is:

1. An exhaust gas control apparatus of an internal combustion engine, the exhaust gas control apparatus of the internal combustion engine being the exhaust gas control apparatus that controls exhaust gas discharged from an engine main body, the exhaust gas control apparatus of the internal combustion engine comprising:
an exhaust gas control catalyst that is disposed in an exhaust gas passage of the internal combustion engine and that is configured to control a target component in the exhaust gas:
an electrochemical reactor that is disposed in the exhaust gas passage on a downstream side of an exhaust gas flow direction of the exhaust gas control catalyst and that is configured to control the target component in the exhaust gas when energized; and
a control device that controls energization of the electrochemical reactor based on an active parameter indicating an active state of the exhaust gas control catalyst and an air-fuel ratio parameter related to an air-fuel ratio of an inflow exhaust gas that flows into the electrochemical reactor.

2. The exhaust gas control apparatus according to claim 1, wherein the control device is configured to control the energization of the electrochemical reactor such that the energization of the electrochemical reactor is performed when the active parameter is a value indicating that the exhaust gas control catalyst is active and the air-fuel ratio parameter is a value indicating that the air-fuel ratio of the inflow exhaust gas is an air-fuel ratio that differs from a stoichiometric air-fuel ratio.

3. The exhaust gas control apparatus according to claim 1, wherein the control device is configured to control the energization of the electrochemical reactor such that the energization of the electrochemical reactor is not performed when the active parameter is a value indicating that the exhaust gas control catalyst is active and the air-fuel ratio parameter is a value indicating that the air-fuel ratio of the inflow exhaust gas is a stoichiometric air-fuel ratio.

4. The exhaust gas control apparatus according to claim 1, further comprising an air-fuel ratio sensor that detects an air-fuel ratio of exhaust gas flowing out of the exhaust gas control catalyst and flowing into the electrochemical reactor,
wherein the air-fuel ratio parameter is an air-fuel ratio detected by the air-fuel ratio sensor.

5. The exhaust gas control apparatus according to claim 1,
wherein the exhaust gas control catalyst is configured to store oxygen, and
wherein the air-fuel ratio parameter is an oxygen storage amount of the exhaust gas control catalyst.

6. The exhaust gas control apparatus according to claim 5, wherein the control device is configured to control the energization of the electrochemical reactor such that the energization of the electrochemical reactor is performed when the active parameter is a value indicating that the exhaust gas control catalyst is active and the oxygen storage amount of the exhaust gas control catalyst is zero or a maximum storable oxygen amount.

7. The exhaust gas control apparatus according to claim 5, wherein the control device is configured to control the energization of the electrochemical reactor such that the energization of the electrochemical reactor is not performed when the active parameter is a value indicating that the exhaust gas control catalyst is active and the oxygen storage amount of the exhaust gas control catalyst is not zero or a maximum storable oxygen amount.

8. The exhaust gas control apparatus according to claim 5,
wherein the control device is configured to control the energization of the electrochemical reactor such that the energization of the electrochemical reactor is performed after a predetermined time has elapsed after the oxygen storage amount of the exhaust gas control catalyst reaches zero or a maximum storable oxygen amount, and
wherein the predetermined time is set to be shorter when a flow rate of the exhaust gas discharged from the engine main body is high than when the flow rate of the exhaust gas discharged from the engine main body is low.

9. The exhaust gas control apparatus according to claim 1, wherein the control device controls the energization of the electrochemical reactor such that the energization of the electrochemical reactor is performed regardless of a value of the air-fuel ratio parameter when the active parameter is a value indicating that the exhaust gas control catalyst is not active.

10. The exhaust gas control apparatus according to claim 1, further comprising an NOx sensor that detects an NOx density in the exhaust gas flowing out of the exhaust gas control catalyst and prior to flowing into the electrochemical reactor,
wherein the active parameter is the NOx density detected by the NOx sensor or a parameter calculated based on the NOx density.
